(19) United States
(12) Patent Application Publication
(10) Pub. No.: US 2023/0224973 A1
(43) Pub. Date: Jul. 13, 2023

(54) METHOD AND APPARATUS FOR SENDING DATA, AND USER EQUIPMENT AND STORAGE MEDIUM

(71) Applicant: Beijing Xiaomi Mobile Software Co., Ltd., Beijing (CN)

(72) Inventor: Xiandong DONG, Beijing (CN)

(21) Appl. No.: 17/996,752

(22) PCT Filed: Apr. 23, 2020
(86) PCT No.: PCT/CN2020/086478

§ 371 Date: Oct. 20, 2022

(51) Int. Cl. H04W 74/08

(52) U.S. Cl. CPC H04W 74/0833

(57) ABSTRACT

A method for sending data, applied to a terminal, includes: determining an uplink synchronization state of the terminal and a state of a physical uplink shared channel (PUSCH) resource pre-configured by a base station for the terminal; and sending, on the physical uplink shared channel (PUSCH) resource data to the base station in response to the terminal being in the uplink synchronization state and the physical uplink shared channel (PUSCH) resource being valid, where the data is data of the terminal in a radio resource control (RRC) inactive state.

### FIELD

The disclosure relates to the technical field of wireless communication but is not limited to the field of wireless technologies, in particular to a method and apparatus for sending data, user equipment and a storage medium.

### BACKGROUND

In the related art of the 5th-generation mobile communication (5G), a state of radio resource control (RRC) includes a radio resource control (RRC) connected state, a radio resource control (RRC) idle state and a radio resource control (RRC) inactive state. At the time that a terminal switches from the radio resource control (RRC) idle state or the radio resource control (RRC) inactive state to the radio resource control (RRC) connected state, a large amount of signaling overhead will be generated.

### SUMMARY

According to a first aspect of the disclosure, a method for sending data is provided, applied to a terminal, and including:

determining an uplink synchronization state of the terminal and a state of a physical uplink shared channel (PUSCH) resource pre-configured by a base station for the terminal; and

sending, on the physical uplink shared channel (PUSCH) resource, data to the base station in response to the terminal being in the uplink synchronization state and the physical uplink shared channel (PUSCH) resource being valid, where the data is data of the terminal in a radio resource control (RRC) inactive state.

According to a second aspect of the disclosure, a communication device is provided, including:

a processor; and

a memory for storing executable instructions of the processor; where

the processor is configured to: implement the method described in any example of the disclosure when running the executable instructions.

According to a third aspect of the disclosure, a non-transitory computer storage medium is provided. The non-transitory computer storage medium stores a computer executable program. The executable program, when executed by a processor, implements the method described in any example of the disclosure.

### BRIEF DESCRIPTION OF THE DRAWINGS

FIG. 1 is a schematic structural diagram of a wireless communication system.

FIG. 2 is a flow diagram of a method for sending data shown according to an example.

FIG. 3 is a flow diagram of a method for sending data shown according to an example.

FIG. 4 is a flow diagram of a method for sending data shown according to an example.

FIG. 5 is a flow diagram of a method for sending data shown according to an example.

FIG. 6 is a flow diagram of a method for sending data shown according to an example.

FIG. 7 is a flow diagram of a method for sending data shown according to an example.

FIG. 8 is a flow diagram of a method for sending data shown according to an example.

FIG. 9 is a block diagram of an apparatus for sending data shown according to an example.

FIG. 10 is a block diagram of user equipment shown according to an example.

FIG. 11 is a block diagram of a base station shown according to an example.

### DETAILED DESCRIPTION

Examples will be described in detail here, and instances of which are represented in accompanying drawings. When the following description refers to the accompanying drawings, the same number in the different accompanying drawings represents the same or similar elements unless otherwise indicated. The implementations described in the following examples do not represent all implementations consistent with the examples of the disclosure. On the contrary, they are merely examples of an apparatus and method consistent with some aspects of the examples of the disclosure as detailed in the appended claims.

The terms used in the examples of the disclosure are merely for the purpose of describing the particular examples, and are not intended to limit the examples of the disclosure. The singular forms “a” and “the” used in the examples of the disclosure and the appended claims are intended to include the plural forms as well, unless the context clearly indicates otherwise. It needs to be further understood that the term “and/or” used here refers to and contains any and all possible combinations of one or more associated listed items.

It needs to be understood that the terms “first”, “second”, “third” and the like may be employed in the examples of the disclosure to describe various information, but these information is not to be limited to these terms. These terms are merely used to distinguish the same type of information from one another. For example, in a case of not departing from the scope of the examples of the disclosure, first information may also be called second information, and similarly, the second information may also be called the first information. Depending on the context, the word if as used here may be interpreted as “at the time of” or “when” or “in response to determining”.

The disclosure relates to the technical field of wireless communication but is not limited to the field of wireless technologies, in particular to a method and apparatus for sending data, user equipment and a storage medium.

In the related art of the 5th-generation mobile communication (5G), a state of radio resource control (RRC) includes a radio resource control (RRC) connected state, a radio resource control (RRC) idle state and a radio resource control (RRC) inactive state. At the time that a terminal switches from the radio resource control (RRC) idle state or the radio resource control (RRC) inactive state to the radio resource control (RRC) connected state, a large amount of signaling overhead will be generated.

In a wireless communication process, the terminal needs to send small data to a base station at the time that the terminal is in the radio resource control (RRC) inactive state. In the related art, a mode in which the small data is sent after switching from the radio resource control (RRC) inactive state to the radio resource control (RRC) connected state is adopted. However, this will bring a large amount of signaling overhead, and the generated signaling overhead is even larger than the data amount of the small data. Moreover, the terminal is frequently made to work in the radio resource control (RRC) connected state, resulting in a large time delay and large power consumption.

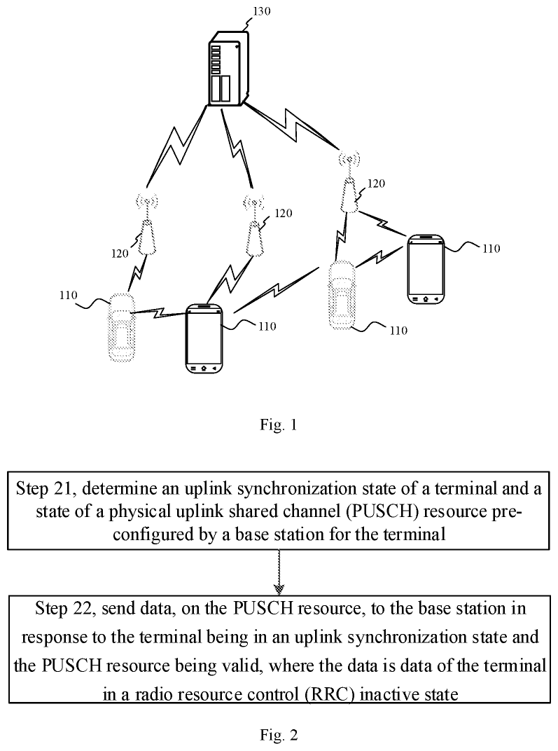

Please refer to FIG. 1, which shows a schematic structural diagram of a wireless communication system provided by an example of the disclosure. As shown in FIG. 1, the wireless communication system is a communication system based on a cellular mobile communication technology, and the wireless communication system may include: a plurality of user equipment 110 and a plurality of base stations 120.

The user equipment 110 may refer to a device that provides voice and/or data connectivity to a user. The user equipment 110 may communicate with one or more core networks via a radio access network (RAN), and the user equipment 110 may be Internet of Thing user equipment, such as a sensor device, a mobile phone (or called a “cellular” phone) and a computer with the Internet of Thing user equipment, for example, may be fixed, portable, pocket-sized, hand-held, computer-built or vehicle-mounted apparatuses. For example, the user equipment may be a station (STA), a subscriber unit, a subscriber station, a mobile station, a mobile, a remote station, an access point, a remote terminal, an access terminal, a user terminal, a user agent, a user device, or the user equipment. Alternatively, the user equipment 110 may also be a device of an unmanned aerial vehicle. Alternatively, the user equipment 110 may also be a vehicle-mounted device, for example, a trip computer with a wireless communication function, or wireless user equipment externally connected to the trip computer. Alternatively, the user equipment 110 may also be a roadside device, for example, may be a streetlight, a signal light, or other roadside devices with the wireless communication function.

The base station 120 may be a network-side device in the wireless communication system. The wireless communication system may be a 4th generation mobile communication (4G) system, also known as a long term evolution (LTE) system; alternatively, the wireless communication system may also be a 5G system, also known as a new radio system or a 5G NR system. Alternatively, the wireless communication system may also be a next-generation system of the 5G system. An access network in the 5G system may be called a new generation-radio access network (NG-RAN).

The base station 120 may be an evolved base station (eNB) employed in the 4G system. Alternatively, the base station 120 may also be a base station (gNB) that employs a centralized distributed architecture in the 5G system. In response to determining that the base station 120 employs the centralized distributed architecture, the base station usually includes a central unit (CU) and at least two distributed units (DUs). The central unit is provided with protocol stacks of a packet data convergence protocol (PDCP) layer, a radio link control (RLC) protocol layer, and a media access control (MAC) layer; and the distributed unit is provided with a physical (PHY) layer protocol stack. The specific implementation of the base station 120 is not limited in the examples of the disclosure.

A wireless connection may be established between the base station 120 and the user equipment 110 through a wireless radio. In different implementations, the wireless air interface is a wireless radio based on the 4th generation mobile communication network technology (4G) standard; alternatively, the wireless radio is a wireless radio based on the 5th generation mobile communication network technology (5G) standard, for example, the wireless radio is a new radio; alternatively, the wireless radio may also be a wireless radio based on a next generation of 5G mobile communication network technology standard.

In some examples, an end to end (E2E) connection may also be established between the user equipment 110, for example, vehicle to vehicle (V2V) communication, vehicle to infrastructure (V2I) communication, vehicle to pedestrian (V2P) communication and other scenarios in vehicle to everything (V2X) communication.

Here, the above user equipment may be regarded as a terminal device of the following examples.

In some examples, the above wireless communication system may further contain a network management device 130.

The plurality of base stations 120 are respectively connected with the network management device 130. The network management device 130 may be a core network device in the wireless communication system. For example, the network management device 130 may be a mobility management entity (MME) in an evolved packet core (EPC) network. Alternatively, the network management device may also be other core network devices, such as a serving gateway (SGW), a public data network gateway (PGW), a policy and charging rules function (PCRF) or a home subscriber server (HSS). An implementation form of the network management device 130 is not limited in the example of the disclosure.

In order to facilitate understanding of any example of the disclosure, a method for transmitting data is first described through one example.

At the time of being in a radio resource control (RRC, Radio Resource Control) inactive state, the terminal may transmit small data to the base station. In one example, the terminal may transmit uplink small data on a 4-step access random access channel (RACH) or a 2-step access random access channel (RACH).

In one example, the terminal maintains uplink synchronization in a radio resource control (RRC) connected state mainly by maintaining a TimeAlignmentTimer. Timing time of the TimeAlignmentTimer may be 0.1 s, 0.75 s, 1.28 s, 1.92 s, 2.5 s, 5.1 s, 10.2 s and the like.

In one example, at the time that the TimeAlignmentTimer is running (or is valid), the terminal confirms that uplink transmission is synchronous, and the terminal may transmit data to the base station. At the time that the TimeAlignmentTimer stops running (or is invalid), the terminal confirms that the uplink transmission is out of synchronism. At this time, in order to reduce conflict of wireless communication, the terminal cannot transmit data to the base station, and the terminal can merely transmit the data after random access by sending a preamble to the base station.

In one example, the terminal is in the radio resource control (RRC) connected state, and the base station implements uplink grant of the terminal by sending activation information once. In a case that the terminal does not receive deactivation information, it will use a radio resource indicated by the first uplink grant for uplink transmission all the way. A process of uplink grant includes configuring resources in a ConfiguredUplinkGrant field of an information element (IE).

In one example, ConfiguredUplinkGrant includes a configured grant type 1. At the time that the configuration is the configured grant type 1, configuration of the ConfiguredUplinkGrant field includes parameters related to radio resources such as a time domain resource, a frequency domain resource, a modulation and coding scheme, an antenna port, and a demodulation reference signal. Here, valid time of the configured resources may be implemented by maintaining a configuredGrantTimer.

At the time that the terminal in the radio resource control (RRC) inactive state needs to transmit small data and timing advanced (TA) is valid, the configured radio resources may be selected to send the small data.

Here, it needs to be noted that the small data may be data with the number of bits or bytes occupied being less than a set threshold. For example, the small data is data with the number of bits occupied being less than 25 bits. Here, the small data may be a heartbeat data packet or an authentication data packet.

As shown in FIG. 2, the present example provides a method for sending data, applied to a terminal, and including:

step 21, an uplink synchronization state of the terminal and a state of a physical uplink shared channel (PUSCH) resource pre-configured by a base station for the terminal are determined.

Here, the terminal may be, but not limited to, a mobile phone, a wearable device, a vehicle-mounted terminal, a road side unit (RSU), a smart home terminal, an industrial sensing device and/or a medical device, and the like.

In one example, the uplink synchronization state of the terminal includes being in an uplink synchronization state and being in a non-uplink synchronization state.

In one example, the base station may configure a first timer for each terminal through a radio resource control (RRC) signaling, and the terminal determines whether the terminal is in the uplink synchronization state or in the non-uplink synchronization state according to a timing state of the first timer.

In one example, the terminal is in the uplink synchronization state after the first timer runs and before timing times out. When the first timer times out, the uplink synchronization state of the terminal is invalid. The terminal is in the non-uplink synchronization state before the first timer is restarted.

In one example, the first timer starts to time at the time that the terminal is in a radio resource control (RRC) connected state, and continues to time up until timeout after the terminal switches to a radio resource control (RRC) inactive state.

In another example, the first timer starts to time after the terminal switches to the radio resource control (RRC) inactive state.

In one example, the terminal may periodically receive a time advance (TA) command sent by the base station, and each time advance (TA) corresponds to a valid duration. After each time the terminal receives the time advance (TA) command sent by the base station, the terminal resets the first timer to zero, and set duration to the valid duration of the time advance (TA). After the first timer times out, the uplink synchronization state of the terminal is invalid, and if the terminal fails to receive any time advance (TA) command, the terminal determines that the terminal is in the non-uplink synchronization state. At this time, the terminal can no longer perform uplink data transmission, but needs to make the terminal be in the uplink synchronization state through a random access procedure, and then perform data transmission.

In one example, the base station may pre-configure the physical uplink shared channel (PUSCH) resource for the terminal through a radio resource control (RRC) signaling. Here, the physical uplink shared channel (PUSCH) resource includes a time domain resource and a frequency domain resource.

In one example, the base station may pre-allocate and notify the terminal of a plurality of unlicensed physical uplink shared channel (PUSCH) resources. In one example, in response to determining that there is a need for uplink data transmission, the terminal may select at least one unlicensed physical uplink shared channel (PUSCH) resource from the plurality of unlicensed physical uplink shared channel (PUSCH) resources pre-allocated by the base station to send uplink data.

In one example, the state of the physical uplink shared channel (PUSCH) resource includes a valid state of the physical uplink shared channel (PUSCH) resource and an invalid state of the physical uplink shared channel (PUSCH) resource.

In one example, the base station may configure a second timer for each terminal through the radio resource control (RRC) signaling, and the terminal determines whether the physical uplink shared channel (PUSCH) resource is in the valid state or the invalid state according to a timing state of the second timer.

In one example, the physical uplink shared channel (PUSCH) resource is in the valid state after the second timer runs and before timing times out. The physical uplink shared channel (PUSCH) resource is in the invalid state at the time that the second timer times out.

In one example, the second timer starts to time at the time that the terminal is in the radio resource control (RRC) connected state, and continues to time up until timing times out after the terminal switches to the radio resource control (RRC) inactive state.

In another example, the second timer starts to time after the terminal switches to the radio resource control (RRC) inactive state.

Step 22, data is sent, on the physical uplink shared channel (PUSCH) resource, to the base station in response to the terminal being in the uplink synchronization state and the physical uplink shared channel (PUSCH) resource being valid, where the data is data of the terminal in the radio resource control (RRC) inactive state.

In one example, the terminal is a terminal in the radio resource control (RRC) inactive state.

In one example, the terminal determines the state of the physical uplink shared channel (PUSCH) resource based on operation of the second timer. Here, the physical uplink shared channel (PUSCH) resource is determined to be in the valid state after the second timer runs and before timing times out.

In one example, the terminal in the radio resource control (RRC) inactive state is in the uplink synchronization state, the physical uplink shared channel (PUSCH) resource is valid, and when the terminal needs to send small data to the base station, the data is sent, on the physical uplink shared channel (PUSCH) resource, to the base station in the radio resource control (RRC) inactive state.

In one example, the small data is data with the number of bits occupied being less than a set threshold. In one example, the set threshold may be 25 bits. For example, the small data may be a heartbeat data packet or an authentication data packet.

In one example, sending the data, on the physical uplink shared channel (PUSCH) resource, to the base station means that the terminal sends the data to the base station at the time that the terminal is in the radio resource (RRC) inactive state.

In the example of the disclosure, the terminal in the radio resource control (RRC) inactive state determines whether to send, on the physical uplink shared channel (PUSCH) resource, the data to the base station according to the uplink synchronization state of the terminal and state of the physical uplink shared channel (PUSCH) resource pre-set by the base station for the terminal. When it is determined that the terminal is in the uplink synchronization state and the physical uplink shared channel (PUSCH) resource is valid, in the radio resource control (RRC) inactive state, the data may be sent, on the physical uplink shared channel (PUSCH) resource, to the base station. Compared with a mode in which a terminal needs to switch from a radio resource control (RRC) inactive state to a radio resource control (RRC) connected state before sending the data to the base station, signaling overhead is small, time delay is short, and power consumption is low.

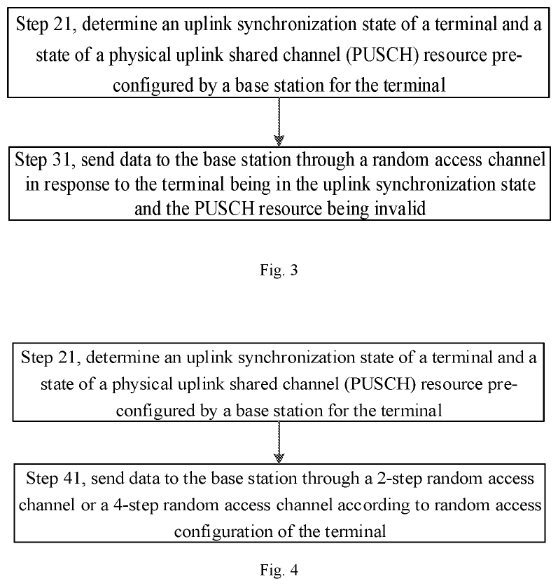

As shown in FIG. 3, the present example further provides a method for sending data, further including:

step 31, data is sent to a base station through a random access channel in response to a terminal being in an uplink synchronization state and a physical uplink shared channel (PUSCH) resource being invalid.

In one example, the terminal is a terminal in a radio resource control (RRC) inactive state.

In one example, the terminal determines a state of the physical uplink shared channel (PUSCH) resource based on operation of a second timer. Here, the PUSCH resource is determined to be in the invalid state after the second timer runs and timing times out. The random access channel includes a 2-step random access channel and a 4-step random access channel. Access delay of 2-step random access is less than that of 4-step random access. That is, an access rate of the 2-step random access is greater than that of the 4-step random access.

Here, the data may further be sent to the base station through the random access channel in response to the terminal being in the uplink synchronization state and the physical uplink shared channel (PUSCH) resource being invalid. A plurality of modes of sending the data to the base station are provided for the terminal in the radio resource control (RRC) inactive state. In this way, a situation that the data cannot be sent to the base station due to invalidation of the physical uplink shared channel (PUSCH) resource and meanwhile there is a single way of sending data to the base station is reduced.

In one example, at the time that service of the terminal is low-delay and/or high-rate service, the data is sent to the base station through the 2-step random access channel.

In one example, the low-delay and/or high-rate service may be service such as ultra-high-definition video, video conferencing, and 3D games in an enhanced mobile broadband scenario.

In another example, the low-delay and/or high-rate service may further be service such as Internet of Vehicles, industrial control, and telemedicine in a low-delay and high-reliability scenario.

As shown in FIG. 4, the present example further provides a method for sending data. In step 31, sending the data to the base station through the random access channel includes:

step 41, the data is sent to the base station through the 2-step random access channel or the 4-step random access channel according to random access configuration of the terminal.

In one example, the random access configuration may configure the terminal to support 2-step random access and/or configure the terminal to support 4-step random access.

In one example, the terminal may receive a system message that carries random access configuration information sent by the base station. The random access configuration information is determined according to the system message.

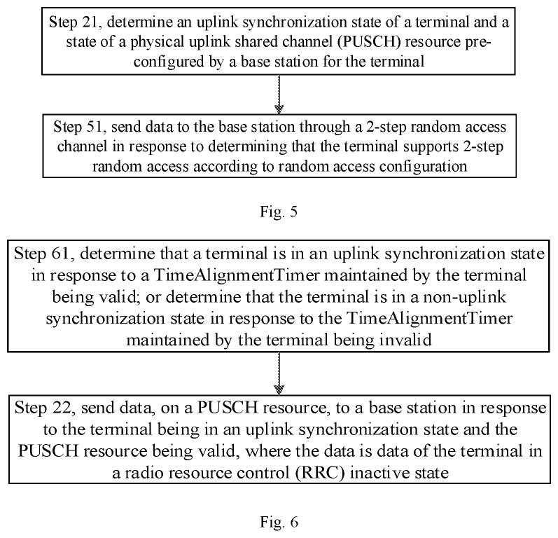

As shown in FIG. 5, the present example further provides a method for sending data. In step 41, sending the data to the base station through the 2-step random access channel or the 4-step random access channel according to random access configuration of the terminal includes:

step 51, the data is sent to the base station through the 2-step random access channel in response to determining that the terminal supports 2-step random access according to the random access configuration.

Here, since data transmission through the 2-step random access channel is shorter in time delay and faster in rate than that of the 4-step random access channel, the efficiency of data transmission can be improved.

In one example, sending the data to the base station through the 2-step random access channel or the 4-step random access channel according to the random access configuration of the terminal further includes:

the data is sent to the base station through the 4-step random access channel in response to determining that the terminal does not support the 2-step random access according to the random access configuration.

Here, the data may further be sent to the base station through the 4-step random access channel in response to determining that the terminal is in the uplink synchronization state, the physical uplink shared channel (PUSCH) resource is invalid, and the terminal does not support the 2-step random access. A plurality of modes of sending the data to the base station are provided for the terminal in the radio resource control (RRC) inactive state. In this way, a situation that the data cannot be sent to the base station due to invalidation of the physical uplink shared channel (PUSCH) resource and meanwhile there is a single way of sending data to the base station is reduced.

As shown in FIG. 6, the present example further provides a method for sending data. In step 22, determining the uplink synchronization state of the terminal and the state of the physical uplink shared channel (PUSCH) resource pre-configured by the base station for the terminal includes:

step 61, it is determined that the terminal is in the uplink synchronization state in response to a TimeAlignmentTimer maintained by the terminal being valid;

or,

it is determined that the terminal is in a non-uplink synchronization state in response to the TimeAlignmentTimer maintained by the terminal being invalid.

In one example, the base station may configure one TimeAlignmentTimer for each terminal through a radio resource control (RRC) signaling, and the terminal determines whether the terminal is in the uplink synchronization state or in the non-uplink synchronization state according to a timing state of the TimeAlignmentTimer.

In one example, the terminal is in the uplink synchronization state after the TimeAlignmentTimer runs and before timing times out. When the TimeAlignmentTimer times out, the uplink synchronization state of the terminal is invalid. The terminal is in the non-uplink synchronization state before the TimeAlignmentTimer is started.

In one example, the TimeAlignmentTimer starts to time at the time that the terminal is in the radio resource control (RRC) connected state, and continues to time up until timing times out after the terminal switches to the radio resource control (RRC) inactive state.

In another example, the TimeAlignmentTimer starts to time after the terminal switches to the radio resource control (RRC) inactive state.

In one example, the terminal may periodically receive a time advance (TA) command sent by the base station, and each time advance (TA) corresponds to a valid duration. After each time the terminal receives the time advance (TA) command sent by the base station, the terminal resets the TimeAlignmentTimer to zero, and set duration to the valid duration of the time advance (TA). After the TimeAlignmentTimer times out, if the terminal fails to receive any time advance (TA) command, the terminal determines that the terminal is in the non-uplink synchronization state. At this time, the terminal can no longer perform uplink data transmission, but needs to make the terminal be in the uplink synchronization state through a random access procedure, and then perform data transmission.

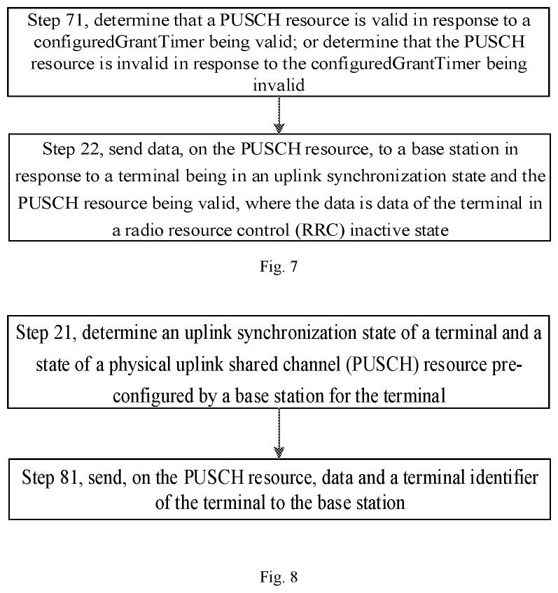

As shown in FIG. 7, the present example further provides a method for sending data. In step 21, determining the uplink synchronization state of the terminal and the state of the physical uplink shared channel (PUSCH) resource pre-configured by the base station for the terminal includes:

step 71, it is determined that the physical uplink shared channel (PUSCH) resource is valid in response to a configuredGrantTimer being valid;

or,

it is determined that the physical uplink shared channel (PUSCH) resource is invalid in response to the configuredGrantTimer being invalid.

In one example, the base station may configure one configuredGrantTimer for each terminal through the radio resource control (RRC) signaling, and the terminal determines whether the PUSCH resource is in the valid state or the invalid state according to a timing state of the configuredGrantTimer.

In one example, the physical uplink shared channel (PUSCH) resource is in the valid state after the configuredGrantTimer runs and before timing times out. The physical uplink shared channel (PUSCH) resource is in the invalid state at the time that the configuredGrantTimer times out.

In one example, the configuredGrantTimer starts to time at the time that the terminal is in the radio resource control (RRC) connected state, and continues to time up until timing times out after the terminal switches to the radio resource control (RRC) inactive state.

In another example, the configuredGrantTimer starts to time after the terminal switches to the radio resource control (RRC) inactive state.

In one example, configuration of the timing duration of the configuredGrantTimer may be implemented in a ConfiguredUplinkGrant field of an information element (IE).

As shown in FIG. 8, the present example further provides a method for sending data. In step 22, sending, on the physical uplink shared channel (PUSCH) resource, the data to the base station includes:

step 81, the data and a terminal identifier of the terminal are sent, on the physical uplink shared channel (PUSCH) resource, to the base station.

In one example, the terminal identifier is an identifier for distinguishing terminal identity. The different terminals have different terminal identifiers.

In one example, after receiving the data, the base station may confirm the terminal sending the data according to the terminal identifier.

In one example, the terminal identifier includes: an inactive radio network temporary identifier (I-RNTI) of the terminal.

In one example, the inactive wireless network temporary identifier occupies 24 or 40 bits.

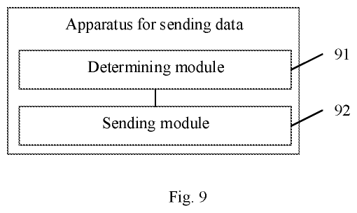

As shown in FIG. 9, an example of the disclosure provides an apparatus for sending data, applied to a terminal. The apparatus includes a determining module 91 and a sending module 92.

The determining module 91 is configured to determine an uplink synchronization state of the terminal and a state of a physical uplink shared channel (PUSCH) resource pre-configured by a base station for the terminal.

The sending module 92 is configured to send, on the physical uplink shared channel (PUSCH) resource, data to the base station in response to the terminal being in the uplink synchronization state and the physical uplink shared channel (PUSCH) resource being valid, where the data includes data of the terminal in a radio resource control (RRC) inactive state.

In one example, the sending module 92 is further configured to:

send the data to the base station through a random access channel in response to the terminal being in the uplink synchronization state and the physical uplink shared channel (PUSCH) resource being invalid.

In one example, the sending module 92 is further configured to:

send the data to the base station through a 2-step random access channel or a 4-step random access channel according to random access configuration of the terminal.

In one example, the sending module 92 is further configured to:

send the data to the base station through the 2-step random access channel in response to determining that the terminal supports 2-step random access according to the random access configuration.

In one example, the sending module 92 is further configured to:

send the data to the base station through the 4-step random access channel in response to determining that the terminal does not support the 2-step random access according to the random access configuration.

In one example, the determining module 91 is further configured to:

determine that the terminal is in the uplink synchronization state in response to a TimeAlignmentTimer maintained by the terminal being valid;

or,

determine that the terminal is in a non-uplink synchronization state in response to the TimeAlignmentTimer maintained by the terminal being invalid.

In one example, the determining module 91 is further configured to:

determine that the physical uplink shared channel (PUSCH) resource is valid in response to a configuredGrantTimer being valid;

or,

determine that the physical uplink shared channel (PUSCH) resource is invalid in response to the configuredGrantTimer being invalid.

In one example, the sending module 92 is further configured to send, on the physical uplink shared channel (PUSCH) resource, the data and a terminal identifier of the terminal to the base station.

In one example, the terminal identifier includes: an inactive radio network temporary identifier (I-RNTI) of the terminal.

As for the apparatus in the above examples, the specific modes for executing operations by all the modules have been described in the examples related to the method in detail, which is not illustrated in detail here.

An example of the disclosure provides a communication device, including:

a processor; and

a memory for storing executable instructions of the processor; where

the processor is configured to: implement the method described in any example of the disclosure when running the executable instructions.

The processor may include various types of storage media, which are non-transitory computer storage media that can continue to memorize information stored on it after the communication device is powered down.

The processor may be connected with the memory through a bus or the like, for reading an executable program stored on the memory.

The example of the disclosure further provides a non-transitory computer storage medium. The non-transitory computer storage medium stores a computer executable program. The executable program, when executed by a processor, implements the method described in any example of the disclosure.

As for the apparatus in the above examples, the specific modes for executing operations by all the modules have been described in the examples related to the method in detail, which is not illustrated in detail here.

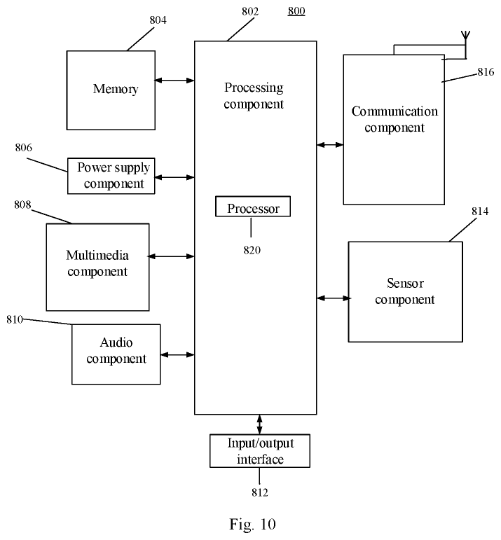

FIG. 10 is a block diagram of user equipment (UE) 800 shown according to an example. For example, the user equipment 800 may be a mobile telephone, a computer, digital broadcast user equipment, a message transceiving device, a game console, a tablet device, a medical device, a fitness device, a personal digital assistant, and the like.

Referring to FIG. 10, the user equipment 800 may include one or more of the following components: a processing component 802, a memory 804, a power supply component 806, a multimedia component 808, an audio component 810, an input/output (I/O) interface 812, a sensor component 814, and a communication component 816.

The processing component 802 usually controls overall operation of the user equipment 800, such as operations associated with displaying, telephone calling, data communication, a camera operation and a record operation. The processing component 802 may include one or more processors 820 to execute an instruction, so as to complete all or part of steps of the above method. In addition, the processing component 802 may include one or more modules, so as to facilitate interaction between the processing component 802 and other components. For example, the processing component 802 may include a multimedia module, so as to facilitate interaction between the multimedia component 808 and the processing component 802.

The memory 804 is configured to store various types of data so as to support operations on the user equipment 800. Instances of these data include instructions of any application programs or methods configured to be operated on the user equipment 800, contact data, telephone directory data, messages, pictures, videos, and the like. The memory 804 may be implemented by any type of volatile or nonvolatile storage device or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 806 provides electric power for various components of the user equipment 800. The power supply component 806 may include a power management system, one or more power sources, and other components associated with generating, managing and distributing electric power for the user equipment 800.

The multimedia component 808 includes a screen providing an output interface between the user equipment 800 and a user. In some examples, the screen may include a liquid crystal display (LCD) and a touch panel (TP). If the screen includes the touch panel, the screen may be implemented as a touch screen so as to receive an input signal from the user. The touch panel includes one or more touch sensors to sense touching, swiping and gestures on the touch panel. The touch sensor may not merely sense a boundary of a touching or swiping action, but also detect duration and pressure related to the touching or swiping operation. In some examples, the multimedia component 808 includes a front camera and/or a back camera. When the user equipment 800 is in an operation mode, such as a shooting mode or a video mode, the front camera and/or the back camera may receive external multimedia data. Each front camera and each back camera may be a fixed optical lens system or have a focal length and optical zooming capability.

The audio component 810 is configured to output and/or input an audio signal. For example, the audio component 810 includes a microphone (MIC). When the user equipment 800 is in the operation mode, such as a call mode, a recording mode or a speech recognition mode, the microphone is configured to receive an external audio signal. The received audio signal may be further stored in the memory 804 or sent via the communication component 816. In some examples, the audio component 810 further includes a speaker for outputting the audio signal.

The I/O interface 812 provides an interface between the processing component 802 and a peripheral interface module, and the above peripheral interface module may be a keyboard, a click wheel, buttons, etc. These buttons may include but are not limited to: a home button, a volume button, a start button and a lock button.

The sensor component 814 includes one or more sensors for providing state evaluations of all aspects for the user equipment 800. For example, the sensor component 814 may detect an on/off state of the equipment 800 and relative positioning of components, for example, the components are a display and a keypad of the user equipment 800. The sensor component 814 may further detect position change of the user equipment 800 or one component of the user equipment 800, whether there is contact between the user and the user equipment 800, azimuth or speed up/speed down of the user equipment 800, and temperature change of the user equipment 800. The sensor component 814 may include a proximity sensor, and is configured to detect existence of a nearby object without any physical contact. The sensor component 814 may further include an optical sensor, such as a CMOS or CCD image sensor, for use in imaging application. In some examples, the sensor component 814 may further include an acceleration sensor, a gyroscope sensor, a magnetic sensor, a pressure sensor or a temperature sensor.

The communication component 816 is configured to facilitate wired or wireless communication between the user equipment 800 and other devices. The user equipment 800 may access into a wireless network based on a communication standard, such as WiFi, 2G or 3G, or their combination. In an example, the communication component 816 receives a broadcast signal or broadcast related information from an external broadcast management system via a broadcast channel In one example, the communication component 816 further includes a near-field communication (NFC) module so as to facilitate short-range communication. For example, the NFC module may be implemented based on a radio frequency identification (RFID) technology, an infrared data association (IrDA) technology, an ultra wide band (UWB) technology, a Bluetooth (BT) technology and other technologies.

In the example, the user equipment 800 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements for executing the above method.

In the example, a non-transitory computer readable storage medium including an instruction is further provided, such as a memory 804 including an instruction. The above instruction may be executed by a processor 820 of the user equipment 800 so as to complete the above method. For example, the non-transitory computer readable storage medium may be an ROM, a random access memory (RAM), a CD-ROM, a magnetic tape, a floppy disk, an optical data storage device and the like.

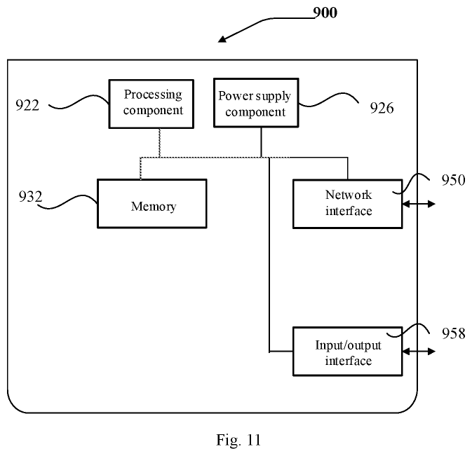

As shown in FIG. 11, an example of the disclosure shows a structure of a base station. For example, the base station 900 may be provided as a network-side device. Referring to FIG. 11, the base station 900 includes a processing component 922, which further includes one or more processors, and a memory resource represented by a memory 932, for storing instructions executable by the processing component 922, such as an application program. The application program stored in the memory 932 may include one or more modules with each corresponding to a set of instructions. In addition, the processing component 922 is configured to execute the instructions so as to execute any of the aforementioned methods applied to the base station, for example, the methods shown in FIG. 2-FIG. 6.

The base station 900 may further include a power supply component 926 configured to execute power management of the base station 900, a wired or wireless network interface 950 configured to connect the base station 900 to a network, and an input/output (I/O) interface 958. The base station 900 may operate based on an operating system stored in a memory 932, such as Windows Server™, Mac OS X™, Unix™, Linux™, FreeBSD™ or the like.

Those of skill in the art will easily figure out other implementation solutions of the disclosure after considering the specification and practicing the disclosure disclosed here. The disclosure intends to cover any transformation, usage or adaptive change of the disclosure, and these transformations, usages or adaptive changes conform to a general principle of the disclosure and include common general knowledge or conventional technical means which are not disclosed here in the technical field. The specification and the examples are merely regarded as an example.

It will be appreciated that the disclosure is not limited to the exact construction that has been described above and shown in the accompanying drawings, and that various modifications and changes may be made without departing from its scope.

According to a first aspect of an example of the disclosure, a method for sending data is provided, applied to a terminal, and including:

determining an uplink synchronization state of the terminal and a state of a physical uplink shared channel (PUSCH) resource pre-configured by a base station for the terminal; and

sending, on the physical uplink shared channel (PUSCH) resource, data to the base station in response to the terminal being in the uplink synchronization state and the physical uplink shared channel (PUSCH) resource being valid, where the data is data of the terminal in a radio resource control (RRC) inactive state.

In one example, the method further includes:

sending the data to the base station through a random access channel in response to the terminal being in the uplink synchronization state and the physical uplink shared channel (PUSCH) resource being invalid.

In one example, sending the data to the base station through the random access channel includes:

sending the data to the base station through a 2-step random access channel or a 4-step random access channel according to random access configuration of the terminal.

In one example, sending the data to the base station through the 2-step random access channel or the 4-step random access channel according to the random access configuration of the terminal includes:

sending the data to the base station through the 2-step random access channel in response to determining that the terminal supports 2-step random access according to the random access configuration.

In one example, sending the data to the base station through the 2-step random access channel or the 4-step random access channel according to the random access configuration of the terminal further includes:

sending the data to the base station through the 4-step random access channel in response to determining that the terminal does not support the 2-step random access according to the random access configuration.

In one example, determining the uplink synchronization state of the terminal and the state of the physical uplink shared channel (PUSCH) resource pre-configured by the base station for the terminal includes:

determining that the terminal is in the uplink synchronization state in response to a TimeAlignmentTimer maintained by the terminal being valid;

or,

determining that the terminal is in a non-uplink synchronization state in response to the TimeAlignmentTimer maintained by the terminal being invalid.

In one example, determining the uplink synchronization state of the terminal and the state of the physical uplink shared channel (PUSCH) resource pre-configured by the base station for the terminal includes:

determining that the physical uplink shared channel (PUSCH) resource is valid in response to a configuredGrantTimer being valid;

or,

determining that the physical uplink shared channel (PUSCH) resource is invalid in response to the configuredGrantTimer being invalid.

In one example, sending, on the physical uplink shared channel (PUSCH) resource, the data to the base station includes:

sending, on the physical uplink shared channel (PUSCH) resource, the data and a terminal identifier of the terminal to the base station.

In one example, the terminal identifier includes: an inactive radio network temporary identifier (I-RNTI) of the terminal.

According to a second aspect of an example of the disclosure, an apparatus for sending data is provided, and applied to a terminal. The apparatus includes a determining module and a sending module, where

the determining module is configured to determine an uplink synchronization state of the terminal and a state of a physical uplink shared channel (PUSCH) resource pre-configured by a base station for the terminal; and

the sending module is configured to send, on the physical uplink shared channel (PUSCH) resource, data to the base station in response to the terminal being in the uplink synchronization state and the physical uplink shared channel (PUSCH) resource being valid, where the data includes data of the terminal in a radio resource control (RRC) inactive state.

In one example, the sending module is further configured to:

send the data to the base station through a random access channel in response to the terminal being in the uplink synchronization state and the physical uplink shared channel (PUSCH) resource being invalid.

In one example, the sending module is further configured to:

send the data to the base station through a 2-step random access channel or a 4-step random access channel according to random access configuration of the terminal.

In one example, the sending module is further configured to:

send the data to the base station through the 2-step random access channel in response to determining that the terminal supports 2-step random access according to the random access configuration.

In one example, the sending module is further configured to:

send the data to the base station through the 4-step random access channel in response to determining that the terminal does not support the 2-step random access according to the random access configuration.

In one example, the determining module is further configured to:

determine that the terminal is in the uplink synchronization state in response to a TimeAlignmentTimer maintained by the terminal being valid;

or,

determine that the terminal is in a non-uplink synchronization state in response to the TimeAlignmentTimer maintained by the terminal being invalid.

In one example, the determining module is further configured to:

determine that the physical uplink shared channel (PUSCH) resource is valid in response to a configuredGrantTimer being valid;

or,

determine that the physical uplink shared channel (PUSCH) resource is invalid in response to the configuredGrantTimer being invalid.

In one example, the sending module is further configured to send, on the physical uplink shared channel (PUSCH) resource, the data and a terminal identifier of the terminal to the base station.

In one example, the terminal identifier includes: an inactive radio network temporary identifier (I-RNTI) of the terminal.

In the example of the disclosure, the terminal in the radio resource control (RRC) inactive state determines whether to send, on the physical uplink shared channel (PUSCH) resource, the data to the base station according to the uplink synchronization state of the terminal and state of the physical uplink shared channel (PUSCH) resource pre-set by the base station for the terminal. When it is determined that the terminal is in the uplink synchronization state and the physical uplink shared channel (PUSCH) resource is valid, in the radio resource control (RRC) inactive state, the data may be sent, on the physical uplink shared channel (PUSCH) resource, to the base station. Compared with a mode in which a terminal needs to switch from a radio resource control (RRC) inactive state to a radio resource control (RRC) connected state before sending the data to the base station, signaling overhead is small, time delay is short, and power consumption is low.

1. A method for sending data, applied to a terminal, and comprising:
determining an uplink synchronization state of the terminal and a state of a physical uplink shared channel (PUSCH) resource pre-configured by a base station for the terminal; and
sending, on the PUSCH resource, data to the base station in response to the terminal being in the uplink synchronization state and the PUSCH resource being valid, wherein the data is data of the terminal in a radio resource control (RRC) inactive state.

2. The method according to claim 1, further comprising:
sending the data to the base station through a random access channel in response to the terminal being in the uplink synchronization state and the PUSCH resource being invalid.

3. The method according to claim 2, wherein sending the data to the base station through the random access channel comprises:
sending the data to the base station through a 2-step random access channel or a 4-step random access channel according to random access configuration of the terminal.

4. The method according to claim 3, wherein sending the data to the base station through the 2-step random access channel or the 4-step random access channel according to the random access configuration of the terminal comprises:
sending the data to the base station through the 2-step random access channel in response to determining that the terminal supports 2-step random access according to the random access configuration.

5. The method according to claim 4, wherein sending the data to the base station through the 2-step random access channel or the 4-step random access channel according to the random access configuration of the terminal further comprises:
sending the data to the base station through the 4-step random access channel in response to determining that the terminal does not support the 2-step random access according to the random access configuration.

6. The method according to claim 1, wherein determining the uplink synchronization state of the terminal and the state of the physical uplink shared channel (PUSCH) resource pre-configured by the base station for the terminal comprises:
determining that the terminal is in the uplink synchronization state in response to a TimeAlignmentTimer maintained by the terminal being valid.

7. The method according to claim 1, wherein determining the uplink synchronization state of the terminal and the state of the physical uplink shared channel (PUSCH) resource pre-configured by the base station for the terminal comprises:
determining that the PUSCH resource is valid in response to a configuredGrantTimer being determining that the PUSCH resource is invalid in response to the configuredGrantTimer being invalid.

8. The method according to claim 1, wherein sending, on the PUSCH resource, the data to the base station comprises:
sending, on the PUSCH resource, the data and a terminal identifier of the terminal to the base station.

9. The method according to claim 8, wherein the terminal identifier comprises: an inactive radio network temporary identifier (I-RNTI) of the terminal.

10-18. (canceled)

19. A communication device, comprising:
an antenna;
a memory; and
a processor, connected with the antenna and the memory respectively, wherein the processor is configured to:
determine an uplink synchronization state of the terminal and a state of a physical uplink shared channel (PUSCH) resource pre-configured by a base station for the terminal; and
send, on the PUSCH resource, data to the base station in response to the terminal being in the uplink synchronization state and the PUSCH resource being valid, wherein the data is data of the terminal in a radio resource control (RRC) inactive state.

20. A non-transitory computer storage medium, wherein the non-transitory computer storage medium stores computer-executable instructions; and the computer-executable instructions, after being executed by a processor, can determine an uplink synchronization state of the terminal and a state of a physical uplink shared channel (PUSCH) resource pre-configured by a base station for the terminal; and send, on the PUSCH resource, data to the base station in response to the terminal being in the uplink synchronization state and the PUSCH resource being valid, wherein the data is data of the terminal in a radio resource control (RRC) inactive state.

21. The method according to claim 1, wherein determining the uplink synchronization state of the terminal and the state of the physical uplink shared channel (PUSCH) resource pre-configured by the base station for the terminal comprises:
determining that the terminal is in a non-uplink synchronization state in response to the TimeAlignmentTimer maintained by the terminal being invalid.

22. The method according to claim 1, wherein determining the uplink synchronization state of the terminal and the state of the physical uplink shared channel (PUSCH) resource pre-configured by the base station for the terminal comprises:
determining that the PUSCH resource is invalid in response to the configuredGrantTimer being invalid.

23. The communication device according to claim 19, wherein the processor is further configured to:
send the data to the base station through a random access channel in response to the terminal being in the uplink synchronization state and the PUSCH resource being invalid.

24. The communication device according to claim 23, wherein the processor is further configured to:
send the data to the base station through a 2-step random access channel or a 4-step random access channel according to random access configuration of the terminal.

25. The communication device according to claim 24, wherein the processor is further configured to:
send the data to the base station through the 2-step random access channel in response to determining that the terminal supports 2-step random access according to the random access configuration.

26. The communication device according to claim 25, wherein the processor is further configured to:
send the data to the base station through the 4-step random access channel in response to determining that the terminal does not support the 2-step random access according to the random access configuration.

27. The communication device according to claim 19, wherein the processor is further configured to:
determine that the terminal is in the uplink synchronization state in response to a TimeAlignmentTimer maintained by the terminal being valid.

28. The communication device according to claim 19, wherein the processor is further configured to:
determine that the PUSCH resource is valid in response to a configuredGrantTimer being valid.

29. The communication device according to claim 19, wherein the processor is further configured to:
send, on the PUSCH resource, the data and a terminal identifier of the terminal to the base station.
